(19) United States
(12) Patent Application Publication
(10) Pub. No.: US 2026/0244031 A1
(43) Pub. Date: Aug. 20, 2026

(54) Glasses temple

(71) Applicant: UVEX ARBEITSSCHUTZ GMBH, Fürth (DE)

(72) Inventors: Tobias KREITSCHMANN, Oberasbach (DE); Martin WOLF, Ansbach (DE)

(21) Appl. No.: 19/164,352

(22) PCT Filed: Feb. 21, 2024
(86) PCT No.: PCT/EP2024/054408

§ 371 Date: Sep. 11, 2025

(30) Foreign Application Priority Data
Mar. 15, 2023 (DE) 10 2023 202 345.8

(51) Int. Cl. G02C 5/16; G02C 5/14; G02C 5/22

(52) U.S. Cl. CPC G02C 5/16; G02C 5/143; G02C 5/22; G02C 2200/16

(57) ABSTRACT

A glasses temple for glasses, in particular for safety goggles, has a hinge end (6), an opposite free end (7), an inner face (10), an outer face (11), an upper face (12), a lower face (13) and at least three passages (15), which each establish a connection between the inner face (10) and the outer face (11) and are arranged alongside one another along a longitudinal extension of the glasses temple. The glasses temple (5) further comprises at least two separating bars (16) which separate the passages (15) from one another and are at different angles to a glasses temple longitudinal line (14).

The contents of German patent application DE 10 2023 202 345.8 are incorporated here by reference.

The invention relates to a glasses temple, in particular for safety goggles. The glasses temple may alternatively be used for example in sports glasses, sunglasses or prescription glasses.

From the prior art, glasses temples are known from public prior use, which often engage around the wearers' ears and are adapted to the curves of their heads. The glasses temples or glasses can thus be held securely on each wearer's head. To improve hold, it is also known for example for the glasses temples to be pressed against the wearer's head with a (high) contact pressure. Wearing glasses comprising glasses temples of this type is often unsatisfactory. The hold or comfort is often poor. A secure hold requires a high contact pressure. The comfort is greater at a lower contact pressure.

U.S. Pat. No. 9,703,117 B2 discloses a glasses temple. The glasses temple has a base body and a cover. The base body and the cover consist of different materials. The base body has a plurality of crossbars extending between an upper edge and a lower edge. The crossbars are at an angle to an edge. They are all at the same angle. This glasses temple does not always ensure a secure or comfortable fit for glasses.

A glasses temple known from U.S. Pat. No. 6,758,562 B1 has a plurality of openings to increase the flexibility of the glasses temple. At least one opening is elongate. The opening is orientated so as to extend substantially vertically.

U.S. Pat. No. 2,659,270 discloses a glasses temple having openings.

The object of the invention is to overcome the drawbacks of the prior art and to provide a glasses temple which provides a particularly secure fit and hold during use and which also offers extremely high comfort. Furthermore, the glasses temple should be capable of adapting as well as possible to different head shapes and sizes.

This object is achieved according to the invention by the features set out in independent claim 1. The central idea of the invention involves the separating bars which separate the passages from one another, for example completely, and which are differently orientated or inclined. At least one of the separating bars advantageously extends at an inclination to the glasses temple longitudinal line or longitudinal direction, which preferably extends curved at least in regions. It is expedient if at least one separating bar extends (substantially) perpendicular to the glasses temple longitudinal line. The separating bars arranged at different inclinations from one another lead to improved comfort and a better fit. They are preferably configured to be flexible. The passages make it possible, for example, to save on material or reduce weight.

The glasses temple is preferably formed from plastics material. It is preferably in a single part or piece.

The glasses temple has at the hinge end at least one hinge element such as a hinge pin, hinge projection, hinge receptacle, hinge opening, hinge hole or the like. The at least one hinge element preferably provides a pivot axis for the glasses temple in the assembled state.

The glasses temple has for example at least one recess, elevation or the like on the inner face and/or outer face thereof. For example, it has different thicknesses.

The passages preferably have different sizes or opening widths. It is expedient for them to have different shapes. It is advantageous if each passage has an angular, for example square, contour on the inner face and/or outer face. Other contours, such as round, oval, elliptical or the like, are alternatively possible. The passages are preferably arranged in a row and advantageously completely closed around the circumference. They are preferably arranged in and/or adjacent to an ear region of the glasses temple. For example, the passages reduce a contact region with the wearer's head when the glasses temple is in use, and thus ensure an improved climate on the head.

Each separating bar preferably has a constant or consistent shape in a longitudinal section of the glasses temple or in a corresponding separating bar cross section. It is expedient for each separating bar to spatially delimit at least one passage in part. Each separating bar is advantageously elongate.

The glasses temple preferably has between two and eight passages and between one and seven separating bars. The arrangement of passages and separating bars is preferably scalable to larger or smaller formations and numbers depending on the application and configuration.

A pair of glasses preferably comprises at least one lens and for example a frame and at least two glasses temples. The glasses temples are preferably hinged to the lens and/or to the frame if present. The pair of glasses is preferably symmetrical.

Further advantageous configurations of the invention are set out in the dependent claims.

The configuration according to dependent claim 2 leads to an improved hold of the glasses during wearing. It is optimised in particular for taking the glasses off.

The configuration according to dependent claim 3 also makes an improved hold possible. It is optimised in particular for putting the glasses on. The separating bars following the hinge end and free end are thus inclined in opposite directions.

The at least one central separating bar according to dependent claim 4 is advantageously arranged between the at least one inclined separating bar following the hinge end and the at least one inclined separating bar following the free end. For example, there are exactly one to three central separating bars. If there are a plurality, they preferably extend (substantially) mutually parallel.

The configuration according to dependent claim 5 also leads to improved comfort and fit. For example, the separating bars have rounded and/or flattened corner regions in the longitudinal section of the glasses temple. When viewed more closely, each separating bar has for example a trapezium shape, which is however substantially triangular overall, in the longitudinal section of the glasses temple.

The separating bars according to dependent claim 6 are preferably formed so as to be functionally optimised or load-optimised. In particular, the angles between adjacent surfaces are different.

The angle according to dependent claim 7 is preferably a rear angle or an angle formed at the rear of the associated separating bar, and advantageously faces away from the hinge end. It is preferably at a clamping angle. The/a clamping angle is preferably acute. It is advantageous if the (free or effective) sides or flanks of the separating bars are each planar.

It is expedient if the separating bars form, in the longitudinal section of the glasses temple, an effective shallow (rear) ramp which comes first when the glasses are put on. Advantageously, the separating bars form, in the longitudinal section of the glasses temple, an effective steep (front) ramp which comes first when the glasses are taken off.

The effective clamping angle preferably depends on usage. It is advantageously shallow when the glasses are put on and preferably steep when they are taken off.

The associated holding projection according to dependent claim 8 provides, for example, a particularly secure and comfortable fit of the glasses temple on the wearer's head. This is particularly advantageous for demanding work, such as overhead work and/or work which involves bending forwards.

Each front holding flank according to dependent claim 9 is preferably exposed at least in part. It is advantageously planar. It is expedient if each front holding flank is formed by a separating bar front face. It is preferably effective when the glasses are put on.

Each rear holding flank according to dependent claim 10 is preferably exposed at least in part. It is advantageous if it is planar. Preferably, each rear holding flank is formed by a separating bar inner face. It is advantageously effective when the glasses are taken off.

The soft component according to dependent claim 12 is preferably formed by a plastics material. It is preferably elastic or resilient. The soft component is advantageously capable of undergoing elastic extension or of flexing. It is expedient if the soft component, in particular by way of a curved configuration, makes use of the depth or thickness of the glasses temple so as to flex. The flexure property preferably counters upward bending and provides a flex-back effect. It makes a pressure-free fit or hold on the wearer's head possible. The glasses temple is thus also capable of adapting to different head widths, for example. The soft component also provides a non-slip hold of the glasses temple on the wearer's head and makes comfortable wearing possible. It is expedient if the soft component extends (substantially) over the entire length of the glasses temple. It is advantageous if the separating bars and/or holding projections are formed at least in part, preferably completely, by the soft component.

The hard component according to dependent claim 13 is advantageously formed from plastics material. It is harder than the soft component and leads to a glasses temple which for example is hard-wearing and provides a secure fit on the wearer's head. The hard component preferably extends (substantially) over the entire length of the glasses temple, preferably at the top. It is comparatively dimensionally stable.

The configuration according to dependent claim 14 also offers the wearer particularly high comfort and improved ergonomics. For example, comfort is increased in an ear region of the glasses temple. The glasses temple is for example twisted in a helical shape. It is expedient if at least 50% of the glasses temple, preferably at least 70% of the glasses temple, preferably the entire glasses temple, is twisted.

The glasses temple according to dependent claim 15 is for example curved only in part or over its entire length, for example uniformly. It is expedient if the glasses temple is adapted to the curvature of the wearer's head and thus curved accordingly. Advantageously, the inner face of the glasses temple is convex at least in regions, and the outer face of the glasses temple is concave at least in regions.

It is expedient if the glasses temple has at least one logo field. Preferably, at least one through-opening is arranged below and/or to the side of the logo field. The at least one through-opening makes for example particularly good ventilation possible, and this in turn increases comfort. As a result of the at least one through-opening, the logo field is in effect free-floating in part. It bears a manufacturer's brand on the outer face, for example. For example, at least one aid or accessory, such as a headband hook, may be directly or indirectly arranged on or attached to the glasses temple of the glasses, preferably detachably, via the at least one through-opening. A through-opening of this type also provides further weight reduction and material savings.

A preferred embodiment of the invention is described in the following by way of example, with reference to the accompanying drawings, in which:

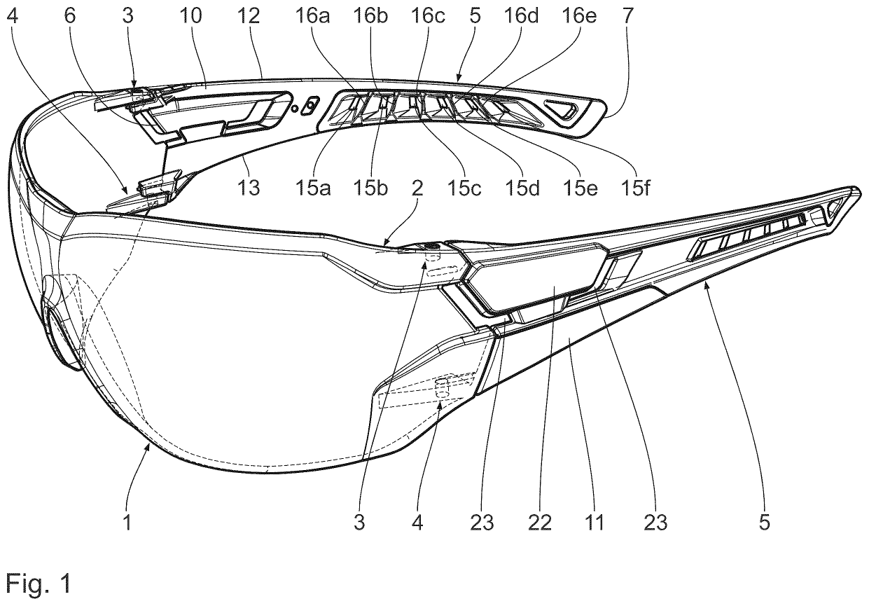

FIG. 1 is a perspective view of a pair of glasses comprising two glasses temples according to the invention,

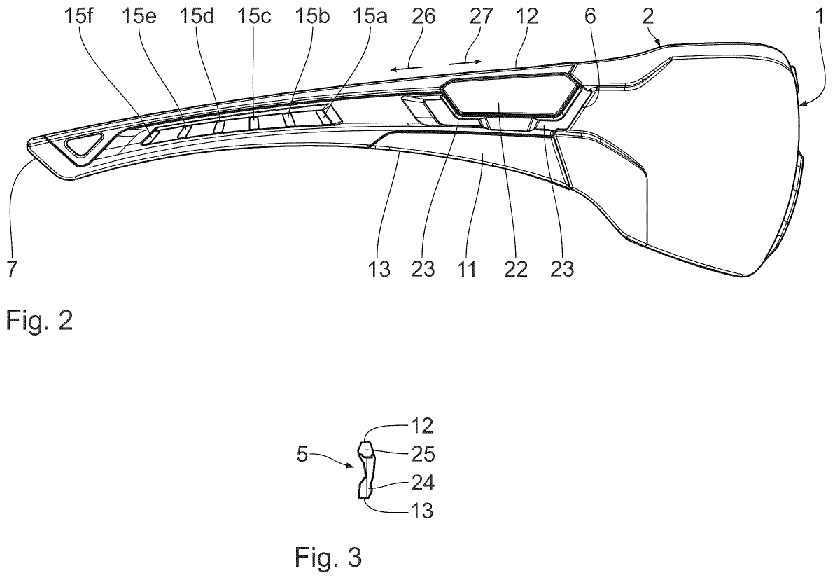

FIG. 2 is a side view of the glasses illustrated in FIG. 1,

FIG. 3 is a cross section through a glasses temple of the glasses shown,

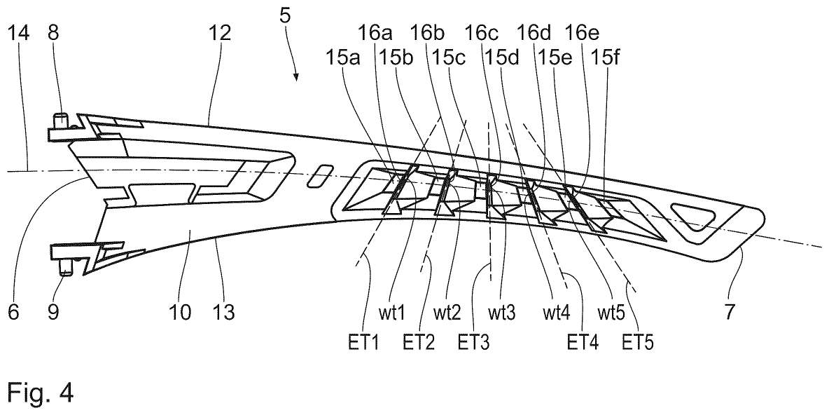

FIG. 4 shows a glasses temple inner face of the glasses temple shown,

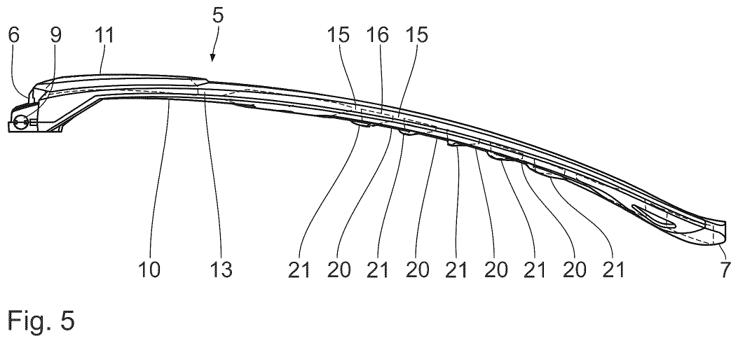

FIG. 5 is a view from below of the glasses temple shown,

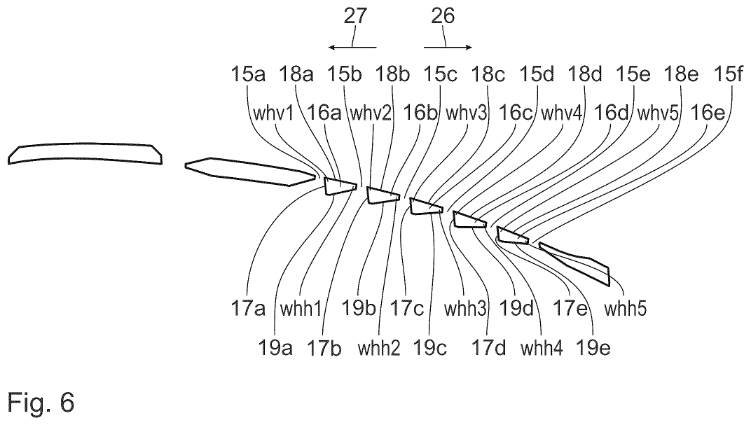

FIG. 6 is a view showing in isolation the separating bars of the illustrated glasses temple, and

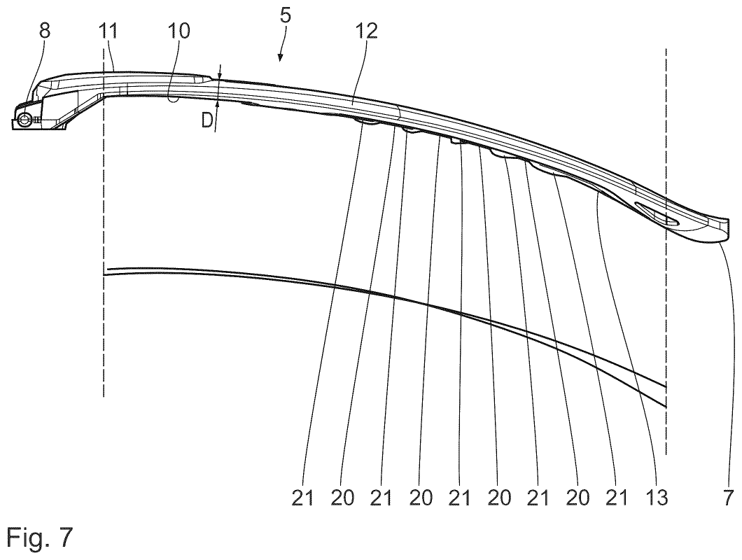

FIG. 7 is a top view of the illustrated glasses temple.

A pair of glasses, shown as a whole in FIGS. 1 and 2, comprises a lens assembly 1 and a frame part 2 arranged at the top of the lens assembly 1. An upper hinge projection 3 and a lower hinge projection 4 are arranged on the inner face of each lateral end region of the lens assembly 1. Each hinge projection 3, 4 has a cylindrical hinge receptacle, which is preferably closed around the circumference. The adjacent hinge receptacles are aligned with one another and define a glasses temple hinge pivot axis.

The glasses also have two glasses temples 5 which, when mounted, are engaged with the hinge receptacles and can thus be pivoted between a folded storage position and an unfolded wearing position (see FIG. 1).

The glasses are symmetrical about a main plane passing through a nose-piece of the lens assembly 1.

The glasses temples 5 are structurally identical. Each glasses temple 5 has a hinge end or front end 6 and a free end or rear end 7 opposite the hinge end 6. Adjacent to the hinge end 6, each glasses temple 5 carries an upper hinge pin 8 and a lower hinge pin 9. Each hinge pin 8, 9 is configured cylindrical and complementary to the associated hinge receptacle (FIG. 4). In the assembled state, each upper hinge pin 8 engages from below in the hinge receptacle of the associated upper hinge projection 3, whilst each lower hinge pin 9 engages from above in the hinge receptacle of the corresponding lower hinge projection 4. Other hinge configurations are alternatively possible.

Each glasses temple 5 further has an inner face 10 and an outer face 11 opposite the inner face 10. In the wearing position, the inner faces 10 of the glasses temples 5 face one another, whilst the outer faces 11 of the glasses temples 5 face away from one another. In the wearing position, the inner faces 10 of the glasses temples 5 extend adjacent to a wearer's head (not shown).

In addition, each glasses temple 5 has an upper face 12 and a lower face 13 opposite the upper face 12. In the wearing position, the upper face 12 extends above the adjacent lower face 13 and faces upwards. The lower face 13 faces downwards.

Each glasses temple 5 is elongate and, in particular uniformly, curved. Each glasses temple 5 has an inner, in particular central, glasses temple longitudinal line or longitudinal axis 14, which is likewise correspondingly curved (FIG. 4).

As is shown for example in FIG. 7 in particular, each glasses temple 5 is also twisted around the glasses temple longitudinal axis 14. For example, the twisting is present, for example uniformly, over the entire glasses temple 5 or only over a sub-region thereof, such as a central region, front end region, and/or rear end region. Each glasses temple 5 is preferably twisted in such a way that the upper face 12 in the region of the free end 7 is further laterally outward in the wearing position than the adjacent lower face 13 of the associated glasses temple 5.

Each glasses temple 5 has a plurality of passages 15, here six passages 15, namely a first passage 15a, a second passage 15b, a third passage 15c, a fourth passage 15d, a fifth passage 15e and a sixth passage 15f. The first passage 15a is at the smallest distance from the hinge end 6. The sixth passage 15f is at the largest distance from the hinge end 6. In each glasses temple 5, the passages 15 are arranged alongside and adjacent to one another along the glasses temple longitudinal line 14. Each passage 15 is closed around the circumference and completely penetrates through the associated glasses temple 5.

The passages 15 arranged in the associated glasses temples 5 differ from one another, in particular in their orientation. A separating bar 16 is arranged between mutually adjacent passages 15. Each glasses temple 5 thus has a plurality of separating bars 16, here five separating bars 16, namely a first separating bar 16a, a second separating bar 16b, a third separating bar 16c, a fourth separating bar 16d and a fifth separating bar 16e. The first separating bar 16a is at the smallest distance from the hinge end 6. The fifth separating bar 16e is at the largest distance from the hinge end 6. Each separating bar 16 extends from a glasses temple region, adjacent to the lower face 13, upwards towards the upper face 12. Each separating bar 16 preferably extends over the entire thickness D of the glasses temple 5 present there, said thickness extending between the inner face 10 and the outer face 11.

The separating bars 16 of each glasses temple 5 are orientated differently (FIG. 4). The first separating bar 16a spans a first separating bar plane ET1, which is at a first separating bar angle wt1 to the glasses temple longitudinal line 14 there. The second separating bar 16b spans a second separating bar plane ET2, which is at a second separating bar angle wt2 to the glasses temple longitudinal line 14 there. The first separating bars 16a and 16b each extend diagonally upwards from a glasses temple region adjacent to the lower face 13, away from the hinge end 6.

The third separating bar 16c, which forms a central separating bar in terms of the separating bar arrangement in the associated glasses temple 5, spans a third separating bar plane ET3, which is at a third angle wt3 to the glasses temple longitudinal line 14 there. The third angle wt3 is (substantially) a right angle. The third separating bar plane ET3 is thus (substantially) perpendicular to the glasses temple longitudinal line 14.

The fourth separating bar 16d spans a fourth separating bar plane ET4, which is at a fourth separating bar angle wt4 to the glasses temple longitudinal line 14 there. The fifth separating bar 16d spans a fifth separating bar plane ET5, which is at a fifth separating bar angle wt5 to the glasses temple longitudinal line 14 there. The fourth and fifth separating bars 16d, 16e extend diagonally upwards from a glasses temple region adjacent to the lower face 13, away from the free end 7.

The first separating bar angle wt1 is less than the second separating bar angle wt2, which in turn is less than the third separating bar angle wt3. The first separating bar angle wt1 is preferably between 60° and 80°. The second separating bar angle wt2 is preferably between 70° and 85°.

The fifth separating bar angle wt5 is less than the fourth separating bar angle wt4, which in turn is less than the third separating bar angle wt3. The fifth separating bar angle wt5 is preferably between 30° and 55°. The fourth separating bar angle wt4 is preferably between 50° and 70°.

The first separating bar plane ET1 and the second separating bar plane ET2 are each at a positive angle to a corresponding perpendicular, whilst the fourth separating bar plane ET4 and the fifth separating bar plane ET5 are at a corresponding negative angle to a corresponding perpendicular. The separating bars 16 are for example arranged or orientated as in amino acid.

As is shown in particular in FIGS. 5 and 6, each separating bar 16 of the associated glasses temple 5 has a substantially triangular shape or form in a longitudinal section thereof.

Each first separating bar 16a has a first separating bar front face 17a and a first separating bar outer face 18a as well as a first separating bar inner face 19a (FIG. 6). Each second separating bar 16b has a second separating bar front face 17b and a second separating bar outer face 18b as well as a second separating bar inner face 19b. Each third separating bar 16c has a third separating bar front face 17c and a third separating bar outer face 18c as well as a third separating bar inner face 19c. Each fourth separating bar 16d has a fourth separating bar front face 17d and a fourth separating bar outer face 18d as well as a fourth separating bar inner face 19d. Each fifth separating bar 16e has a fifth separating bar front face 17e and a fifth separating bar outer face 18e as well as a fifth separating bar inner face 19e. The separating bar front faces 17a to 17e face the hinge end 6. The separating bar outer faces 18a to 18e extend adjacent to or contribute to forming the outer face 11 of the associated glasses temple 5. The separating bar inner faces 19a to 19e extend adjacent to or contribute to forming the inner face 10 of the associated glasses temple 5.

Each separating bar front face 17 preferably forms an, in particular steep, ramp and is advantageously planar. It is expedient if each separating bar outer face 18 is planar. Each separating bar inner face 19 preferably forms an, in particular shallow, ramp and is preferably planar.

Each first separating bar 16a has a rear first holding angle whh1 between its first separating bar outer face 18a and its first separating bar inner face 19a. Each first separating bar 16a has a front first holding angle whv1 between its first separating bar front face 17a and its first separating bar outer face 18a. Each second separating bar 16b has a rear second holding angle whh2 between its second separating bar outer face 18b and its second separating bar inner face 19b. Each second separating bar 16b has a front second holding angle whv2 between its second separating bar front face 17b and its second separating bar outer face 18b. Each third separating bar 16c has a rear third holding angle whh3 between its third separating bar outer face 18c and its third separating bar inner face 19c. Each third separating bar 16c has a front third holding angle whv3 between its third separating bar front face 17c and its third separating bar outer face 18c.

Each fourth separating bar 16d has a rear fourth holding angle whh4 between its fourth separating bar outer face 18d and its fourth separating bar inner face 19d. Each fourth separating bar 16d has a front fourth holding angle whv4 between its fourth separating bar front face 17d and its fourth separating bar outer face 18d. Each fifth separating bar 16e has a rear fifth holding angle whh5 between its fifth separating bar outer face 18e and its fifth separating bar inner face 19e. Each fifth separating bar 16e has a front fifth holding angle whv5 between its fifth separating bar front face 17a and its fifth separating bar outer face 18a.

The separating bar front faces 17 of each glasses temple 5 extend (substantially) mutually parallel. The separating bar outer faces 18 lie on a common curved line.

The front holding angles whv1, whv2, whv3, whv4 and whv5 preferably taper off starting from the hinge end 6. The front first holding angle whv1 is for example between 65° and 85°. The front fifth holding angle whv5 is advantageously between 45° and 65°.

The rear holding angles whh1, whh2, whh3, whh4 and whh5 extend from the hinge end 6. The rear first holding angle whh1 is between 15° and 25°. The rear fifth holding angle whh5 is between 5° and 20°.

Each separating bar 16 projects inwards with respect to a glasses temple base body 20 so as to form a free holding projection 21.

Each glasses temple 5 has externally, for example adjacent to the hinge end 6, a logo field 22 (FIG. 1) capable of bearing a logo such as a trademark. Each glasses temple 5 has a through-opening 23 adjacent to the logo field 22. Each through-opening 23 completely penetrates through the associated glasses temple 5. Here, each through-opening 23 extends below the associated logo field 22 and adjacent to the two ends thereof. Each through-opening 23 is for example interrupted at the bottom to form two partial through-openings. A configuration without a logo field 22 is alternatively possible.

Each glasses temple 5 is configured in one part and as a two-component glasses temple. Each glasses temple 5 has a soft component 24 and a hard component 25, which is firmly connected to the soft component 24 in regions and is harder than it (FIG. 3). The hard component 25 extends adjacent to the upper face 12 of each glasses temple 5. For example, the hinge pins 8, 9 are formed by the hard component 25. The passages 15 are each formed in the soft component 24. The separating bars 16 are also each formed by the soft component 24.

The use of the glasses or of the glasses temples 5 is described in the following. When the glasses are put on, the glasses temples 5 are displaced on the wearer's head in an on direction 26, towards the associated free end 7. The inner faces 10 of the glasses temples 5 face the wearer's head. The holding projections 21 come into contact with the head. In particular, the separating bar inner faces 19 are effective in this case. The soft component 24 makes deflection of the separating bars 16 possible, including the holding projections 21.

When the glasses are taken off, the glasses temples 5 are displaced on the wearer's head in an off direction 27 counter to the on direction 26, towards the hinge end 6. The holding projections 21 are positioned against the wearer's head. In particular, the separating bar front faces 17 are effective. The soft component 24 makes deflection of the separating bars 16 possible, including the holding projections 21.

In particular, the formation and arrangement of the separating bars 16 also makes it possible to prevent the glasses temples 5 from pulling on the hair when the glasses are put on or taken off, which is generally painful.

Each separating bar 16 has, towards the free end or rear end 7, a rear wedge which is at a shallow angle and which creates comparatively little resistance when the glasses are put on. By contrast, a front wedge of the associated separating bar 16 towards the hinge end or front end 6 is at a larger angle, in particular by comparison with the rear angle, and clamps more tightly.

The terms “upper face”, “lower face”, “inner face”, “outer face”, “front”, “rear” or the like used herein refer in particular to wearing of the glasses as intended.

1. A glasses temple for glasses,
(a) having a hinge end,
(b) having a free end opposite the hinge end,
(c) having an inner face for arrangement adjacent to a head of a wearer when the glasses temple is in use,
(d) having an outer face opposite the inner face,
(e) having an upper face,
(f) having a lower face opposite the upper face,
(g) having at least three passages, which
(i) each establish a connection between the inner face and the outer face, and
(ii) are arranged alongside one another along a longitudinal extension of the glasses temple, and
(h) having at least two separating bars, which
(i) separate the passages from one another, and
(ii) are at different angles to a glasses temple longitudinal line.

2. The glasses temple according to claim 1, wherein at least one separating bar following the hinge end extends up-wards at an inclination from a glasses temple region adjacent to the lower face, away from the hinge end, and is at an angle to the glasses temple longitudinal line which angle in each case ranges from 40° to 85°.

3. The glasses temple according to claim 1, wherein at least one separating bar following the free end extends upwards at an inclination from a glasses temple region adjacent to the lower face, away from the free end, and is at an angle to the glasses temple longitudinal line which angle in each case ranges from 30° to 85°.

4. The glasses temple according to claim 1 further having at least three of the separating bars, wherein at least one central separating bar arranged in a central region of the separating bars is at an angle to the glasses temple longitudinal line which in each case ranges from 85° to 95°.

5. The glasses temple according to claim 1, wherein each of the separating bars has a triangular, substantially triangular or trapezium shape in a longitudinal section of the glasses temple.

6. The glasses temple according to claim 5, wherein the shapes of the separating bars are different in the longitudinal section of the glasses temple.

7. The glasses temple according to claim 5, wherein starting from the hinge end an angle decreases between a separating bar outer face, arranged adjacent to the outer face of the glasses temple, and a separating bar inner face, arranged adjacent to the inner face of the glasses temple.

8. The glasses temple according to claim 1, wherein at least two of the separating bars project with respect to the inner face with respect to a glasses temple base body upon forming a respective holding projection.

9. The glasses temple according to claim 8, wherein each holding projection has a front holding flank, which faces the hinge end and which is at a front holding angle to the adjacent outer face which angle in each case is between 30° and 85°.

10. The glasses temple according to claim 8, wherein each holding projection has a rear holding flank, which is at a rear holding angle to the adjacent outer face which angle in each case is between 5° and 60°.

11. The glasses temple according to claim 10, wherein the rear holding angles decrease starting from the hinge end.

12. The glasses temple according to claim 1, further having a soft component in which the passages are formed.

13. The glasses temple according to claim 1, further having a hard component which extends adjacent to the passages above it.

14. The glasses temple according to claim 1, further having at least one region twisted around the glasses temple longitudinal line, the glasses temple overall preferably being twisted through 10° to 25°.

15. The glasses temple according to claim 1, further having a curvature of the glasses temple at least in regions.
